(19) United States
(12) Patent Application Publication
(10) Pub. No.: US 2025/0387944 A1
(43) Pub. Date: Dec. 25, 2025

(54) PANEL FOR FORMING A FLOOR OR WALL COVERING

(71) Applicant: CHAMPION LINK INTERNATIONAL CORPORATION, The Valley (AI)

(72) Inventors: Thomas Luc Martine BAERT, Sint-Martens-Latem (BE); Tom VAN POYER, Jiaxing (CN); Sven BOON, Jiaxing (CN)

(73) Assignee: CHAMPION LINK INTERNATIONAL CORPORATION, The Valley (AI)

(21) Appl. No.: 19/153,722

(22) PCT Filed: Jan. 31, 2024
(86) PCT No.: PCT/EP2024/052336

§ 371 Date: Aug. 5, 2025

(30) Foreign Application Priority Data
Feb. 1, 2023 (NL) 2034068

(51) Int. Cl. B27N 3/04; B27N 7/00; B32B 3/06; B32B 5/06; B32B 29/02

(52) U.S. Cl. CPC B27N 3/04; B27N 7/005; B32B 3/06; B32B 5/06; B32B 29/02; B32B 2250/02; B32B 2260/021; B32B 2262/065; B32B 2307/51; B32B 2307/546; B32B 2307/736; B32B 2307/7375; B32B 2471/00; B32B 2607/00

(57) ABSTRACT

The invention relates to a panel, such as a floor panel, wall panel, or a ceiling panel, comprising at least one core layer and at least one decorative top layer, wherein at least one core layer comprises a significant of natural fibers having an average fiber length of at least 4 mm.

The invention relates to a decorative panel, such as a floor panel, wall panel, or ceiling panel suitable for assembling a surface covering, in particular a waterproof surface covering. The invention also relates to a method for producing such panel.

Decorative floor and wall coverings commonly comprise at least one core layer that is based on wood, natural materials, or derivatives thereof. These natural fibers are generally based on coniferous woods such as poplar or pine. However, the major disadvantage of using wood or natural fibers is the hygroscopic nature of such materials, which affects the lifetime and durability of such panels. When the panel or the edge of the panel is exposed to moisture, these fibers absorb water and deformation occurs. This deformation can damage a plurality of panels when used in part or in full as a decorative flooring, wall, or ceiling surface. Said deformation can include the swelling of the panel in size (EN 13329 Annex C), such as when the moisture content of the surrounding air increases; or can also include the shrinking of the panel when the moisture content is reduced, of up to 0.6-0.7%. It can also include the swelling of the panel in thickness (ISO 24336/NALFA 3.2), when the panel is submerged or directly subjected to water, by up to 20%. The swelling or shrinking rate is exacerbated for thin panels as the deformation ratio becomes progressively larger, so the thinnest panels that can be made with high wood fiber content and that can pass EN 13329 and NALFA requirements are generally 8 mm. According to EN 13329/NALFA, an acceptable thickness swelling rate of laminates for residential (US Class 1) and light commercial (US Class 2) applications is less than or equal to 18%. A lower swelling rate of less than or equal to 15% is then required for heavy commercial applications (US Class 4 or EU Class 33) while an even lower swelling rate of less than or equal to 8% is required for very heavy commercial applications (EU Class 34).

It is therefore an objective of this invention to provide a decorative panel, such as a decorative floor panel or wall panel, which has an improved performance in terms of moisture swelling rate. Additionally, it is a goal of the invention to provide at least an alternative embodiment of a composite panel, specifically a mineral wood composite panel, such as a decorative floor panel, wall panel, or ceiling panel, having competitive material properties with respect to the state of the art.

The invention provides thereto a decorative panel, such as a floor panel, wall panel, or a ceiling panel, comprising at least one core layer, and at least one decorative top layer, wherein at least one core layer comprises in the range of 30 wt % to 80 wt % of natural fibers, in particular 50 wt % to 70 wt % natural fibers, wherein at least 40 wt % and preferably at least 50 wt % of said natural fibers has an average fiber length of at least 3.5 mm and preferably at least 4 mm.

The invention further provides thereto a decorative panel, such as a floor panel, wall panel, or a ceiling panel, comprising at least one core layer, and at least one decorative top layer, wherein at least one core layer comprises in the range of 1 wt. % to 30 wt. %, preferably 1 wt. % to 20 wt. %, even more preferably 1 wt. % to 10 wt. % of microfibrillated cellulose (MFC) by total weight of the core layer. Optionally, the at least one core layer comprises between 70 wt. % to 99 wt. %, preferably between 80 wt. % to 99 wt. %, even more preferably between 90 wt. % to 99 wt. % of inorganic material by total weight of the core layer.

Alternatively, the invention further provides thereto a panel, such as a floor panel, wall panel, or a ceiling panel, comprising:
at least one core layer; and
at least one decorative top layer;
   wherein at least one core layer comprises 1 wt. % to 30 wt. % of microfibrillated cellulose fibrils based on total weight of the at least one core layer, and
   wherein an average fibril length of the microfibrillated cellulose fibrils is at least 10 micrometers.

The panel according to the present invention benefits of having a swelling rate of less than 5%, when tested according to ISO 24336/NALFA 3.2. This is achieved by the addition of specific natural fibers with a certain fiber length and/or length-to-width ratio typically in combination with an increased pressure which is applied when forming the core layer of the panel. A further unexpected improvement of the material comprising the core is obtained by the addition of 70-99 wt. % of inorganic material in combination with 1-30% by weight of 10 micrometers to 300 micrometers long, thin, flexible natural fibers, preferably cellulose fibrils or microcellulose fibrils, more preferably microfibrillated cellulose, and/or nanofibrillated cellulose. The core layer may therefore comprise at least one inorganic additive such as mineral and/or ceramic material. The addition of natural fibers in the range of 30 wt % to 80 wt %, in particular 50 wt % to 70 wt %, wherein at least 40 wt % and preferably at least 50 wt % of said natural fibers has an average fiber length of at least 3.5 mm and preferably at least 4 mm improves the moisture stability, swelling rate, and therefore the water resistance of the said panel. The addition of cellulose fibrils and/or microfibrillated cellulose at a weight % of 1-30%, preferably in synergy with 70-99 wt % of inorganic material improves the moisture stability as well as the physical properties of the panel in ways not foreseen by the prior art. Unexpectedly, even with the addition of inorganic content, the tensile strength as well as the compressive strength and/or flexural strength of the core layer is improved.

As used herein, cellulose fibers and cellulose fibrils are elongated biological materials present in plants. In contrast to cellulose fibers, which have diameters typically ranging between 10 to 100 μm, microfibrillated cellulose fibrils have a much smaller diameter, typically ranging from 10-100 nm. In line therewith, nanofibrillated cellulose fibrils typically have a diameter below 100 nm. Microfibrillated cellulose fibrils are obtainable by removing an outer layer of cellulose fibers, such that fibrils are obtained. Removing the outer layer of fibers and thus releasing the fibrils is possible via mechanical shearing. Fibrils are capable of forming network or web-like structures.

Cellulose is a long linear polysaccharide polymer consisting of β-1,4-linked glucose units (C₅H₈O₄) m, wherein m is an integer indicating the number of units in a cellulose molecule. Cellulose fibers are fibers made from ethers or esters of cellulose, that can be obtained from plant parts, such as bark, wood, or leaves. Cellulose fibers can also be obtained from other plant-based material. Microfibrillated cellulose fibrils and cellulose fibers, as used herein, do not necessarily consist of solely cellulose molecules. Other types of molecules, such as lignin and hemicellulose, may also be present. The microfibrillated cellulose fibrils and cellulose fibers may contain varying percentages of cellulose. Wood fibers in general contain about 40-50% cellulose, while cotton fibers may contain up to 90% cellulose.

A natural material is a material that is still recognizable as being derived from a part of a plant. As such, natural cellulose fibers are cellulose fibers that are derived from a plant.

The natural fibers according to the present invention improve the moisture stability, swelling rate, and therefore the water resistance of the core layer by promoting natural anchors or entanglement-enabling mechanism in the core layer. When the core layer further comprises at least one mineral material, the mineral material creates a stronger bond to the natural fibers via the said natural anchors or entanglement-enabling mechanism in the core layer. It was experimentally found that the use of at least one type of natural fibers and at least one mineral material creates an unexpected synergistic effect of increased water resistance of the core layer and improved physical characteristics, with an optimal effect when combining macrofibers and microfibers, wherein macrofibers are present at a weight % in a range of 30-80%, and microfibers, microcellulose or microfibrillated cellulose at a weight % in a range of 1-30%. Cellulose fibers are an example of macrofibres, whereas microfibrillated cellulose fibrils are an example of microfibers. Fibrils can thus be referred to as microfibers.

It is preferred that at least part of the natural fibers, preferably of the cellulose fibers, are non-coniferous macrofibers, in particular non-coniferous fibers having an average fiber length of at least 4 mm. At least part of the non-coniferous macrofibers is preferably chosen from the groups of abaca, hemp, hemp bast, Hesperaloe changii, seed flax, cotton, and/or Hesperaloe funifera. As used herein, the terms natural fibers and cellulose fibers can be used interchangeably.

It is further preferred that at least a part of the natural fibers consists of microfibers having an average fiber length of at least 10 micrometers, preferably at least 100 micrometers, most preferably at least 300 micrometers, and an average fiber width (diameter) of at most 50 nanometers, more preferably at most 20 nanometers, most preferably at most 10 nanometers. As such, nanofibrillated cellulose fibrils are an example of microfibers as well. At least part of the microfibers is chosen from the group of softwoods such as spruce, pine, fir, hardwoods such as eucalyptus, birch, maple, and/or chosen from the group of abaca, hemp, hemp bast, Hesperaloe changii, seed flax, cotton, and Hesperaloe funifera. In a preferred embodiment, at least part of the natural fibers, microfibers and/or macrofibers are at least partially delignified and/or densified.

In a preferred embodiment, at least part of the natural fibers, cellulose fibers, microfibers and/or macrofibers have an average length-to-diameter ratio of at least 100:1, preferably at least 135:1, more preferably at least 150:1. It was experimentally found that relatively longitudinal natural fibers have a positive effect on both the swelling performance and the elasticity of the panel. It was further experimentally found that partially delignified and/or densified natural fibers have a positive effect on both the swelling performance and the elasticity of the panel, up to an optimal weight percentage. The panel, and in particular the core layer, preferably has a swelling rate of less than 5%, more preferably less than 4%, most preferably less than 3% when tested according to ISO 24336/NALFA 3.2, or an equivalent test. The panel, and/or the core layer, preferably has a modulus of elasticity (MOE) in the range of 4000 to 8000 MPa in particular when tested according to EN 310 or ASTM D790. The panel, and/or the core layer, preferably further has a modulus of rigidity (MOR) higher than 30, preferably higher than 40, most preferably 50-70 Mpa in particular when tested according to EN 310 or ASTM D790.

According to the present invention, at least one decorative top layer is provided or attached to the top surface of the core layer. Herein, the decorative top layer can also be referred to as décor layer or decorative layer, decorative surface, print layer, or a digitally printed layer. At least one decorative top layer can for example be a veneer layer, such as but not limited to wood veneer, a stone wood veneer, a stone veneer and/or a natural veneer layer. In case a stone veneer is applied, the stone veneer preferably comprises a material selected from the group: natural stone, marble, granite, slate, glass and/or ceramic. The decorative top layer may for example comprise a ceramic tile. The decorative top layer preferably comprises cellulose, fibrous, or paper layer having a decorative image or pattern that is provided via digital printing, inkjet printing, rotogravure printing machine, electronic line shaft (ELS) rotogravure printing machine, automatic plastic printing machine, offset printing, flexography, or rotary printing press. Preferably, at least one decorative top layer is a flexible paper that can be used with a roller press or lamination machines which requires that the flexible paper is rollable, pliable, or roller-compatible. Preferably, the thickness of at least one decorative top layer is in the range of 0.05 mm and 0.10 mm, for example substantially 0.07 mm. Preferably, at least one decorative top layer and/or tactile layer is provided via digital printing, inkjet printing, masking printing, single-pass printing directly or indirectly on at least one surface of the core.

The thickness of the panel, and in particular the thickness of the core layer is preferably at most 8 mm, more preferably at most 6 mm. In a preferred embodiment, the panel comprises at least one core layer having a maximum thickness of 8 mm, more preferably 6 mm, or most preferably 4 mm. The density of said core layer is preferably in the range of 1000-1400 kg/m³, more specifically in the range of 1100-1200 kg/m³, by virtue of a high mineral content and/or at least partial delignification and/or at least partial densification of the natural fibers present in the core.

Possibly, at least one core layer comprises wood, engineered wood, wood plastic composite (WPC), medium density fiberboard (MDF), high density fiberboard (HDF), green fiberboard, or mixtures (or combinations and derivatives) thereof. It is conceivable that the core layer comprises multiple types of natural fibers. Preferably, at least one type of natural fibers comprises an average fiber length from 0.9 to 35 mm and/or a fiber width between 4 to 80 microns to provide sufficient natural anchors or entanglement-enabling mechanism in the core layer. The natural fibers form interconnected structures which may have a branching or dendritic appearance or an interconnected three-dimensional structure that resemble the branches of a tree or the dendrites of a neuron.

Other preferred properties of the natural fibers include: a coarseness value between 6 to 30 mg/100 m, a diameter between 3 to 50 microns and/or a length to diameter ratio between 135 to 1000:1. As the individual fibers, macrofibers and/or microfibers align themselves in parallel, but also cross over and interconnect with neighboring fibers, a complex, interconnected structure is formed that can branch and form a highly porous network. At least a part of the microfibers has a surface area of at least 10 m²/g, preferably at least 20, most preferably at least 100 m²/g and a porosity of at least 20%, more preferably at least 30%, most preferably at least 40%. The said values and structures further promote the formation of natural anchors or entanglement-enabling mechanisms in the core layer, in particular when the natural fibers are used with at least one mineral material. Hence, the core layer preferably comprises at least one inorganic mineral material, preferably limestone.

It is conceivable that the formation of MFC networks is brought about by several factors such as the pH of the composition of the core layer, the temperature during the production of the core layer and the additives included in the core layer. It is further conceivable that the pH of the core composition influences the formation of branching patterns in MFC networks. In particular, acidic conditions where the core composition has a pH of less than 4, highly branched MFC networks are created. In yet another embodiment, the MFC fibers are processed at a temperature of at most 50 deg C., preferably at most 30 deg C., and most preferably at most 22 deg C., wherein at said range of temperatures a higher percentage of highly branched networks are formed, which is desired.

In yet another embodiment, the core layer further comprises additives selected from the group: cetyltrimethylammonium bromide (CTAB), Polyethyleneimine (PEI), carboxymethyl cellulose (CMC), chitosan and/or tannic acid. The introduction of CTAB aims to prompt the development of dendritic networks in the core layer by stabilizing the self-assembled structure. Conversely, the incorporation of CMC is intended to encourage the creation of extensively branched networks in the MFC by modifying the surface charge of the fibrils and augmenting their interconnectedness. Additionally, the inclusion of PEI, chitosan, and/or tannic acid is intended for cross-linking MFC fibers, a process demonstrated to enhance the mechanical properties and stability of the core layer.

In a preferred embodiment, at least part of the natural fibers comprises an average fiber length in the range from 4 to 15 mm, preferably in the range from 4.1 to 10 mm, more preferably in the range from 4.5 to 7.5 mm. The relatively long natural fibers have a beneficial effect on the overall properties of the panel. It is also possible that at least part of the natural fibers comprises an average coarseness value between 6 to 30 mg/100 m, preferably between 8 and 25 mg/100 m, more preferably between 10 and 20 mg/100 m. At least part of the natural fibers preferably has an average diameter between 3 to 50 microns, preferably between 5 to 40 microns, more preferably between 7 to 30 microns and/or that at least part of the natural fibers has an average fiber width in the range of 4 to 80 mm, preferably in the range of 7 to 60 mm, more preferably in the range of 8 to 40 mm. At least part of the natural fibers is preferably substantially elongated and/or at least partially round and/or rounded at the distal eds. It is conceivable that at least part of the natural fibers are microfibers with a length ranging from 10 micrometers to 200 micrometers. In order to further enhance the overall properties of the core layer and/or the panel, it is conceivable that at least part of the natural fibers is subjected to a treatment chosen from irradiation treatment and/or surface treatment, in particular microwave treatment, infrared treatment, surface coating, cold treatment and/or heat treatment. The treatment(s) are in particular configured to further enhance the performance of the fibers and the panel. At least part of the natural fibers can be recycled natural fibers. Hence, it is also conceivable that at least part of the natural fibers is composed of a composite in natural materials, in particular recycled natural materials. It is conceivable that at least part of the natural fibers is subjected to a defibration process at a pressure of at least 6 bars, preferably more than 8 bars, thereby increasing the surface roughness and adhesion properties of the fibers, whilst reducing the ability of the fibers to take up or maintain moisture, and/or deform in size when in contact with moisture, through at least partial removal of hemicellulose and/or lignin of the wood fibers, thereby resulting in an at least partial collapse of the cellulose walls, and/or an at least partial densification of at least part of the wood fibers comprised within the core layer.

The natural fibers may allow for an improvement in the swelling rate of the core layer. In particular, the swelling test indicates a swelling rate with values ranging from 2.65% to 5%, most preferably less than 5%, according to ISO 25336.

It is likewise conceivable that the ash content of the at least one core layer is at least 5%, most preferably less than 12%. In a preferred embodiment, the ash content of the at least one core layer is between 6-10%. There are several standard methods for determining the ash content, in particular ASTM D1102: Standard Test Method for Ash in Wood; ISO 3451: Plastics-Determination of ash-Part 1: General methods; ASTM D2584: Standard Test Method for Ignition Loss of Cured Reinforced Resins; and ASTM D5630: Standard Test Method for Ash Content in Plastics.

In a preferred embodiment, the at least one core layer further comprises a composition shown in the table(s) below:

| Material | Content (%) |
|---|---|
| Wood flour | 78.3 |
| Melamine resin | 10.5 |
| Water | 5.7 |
| Epoxy resin | 2.0 |
| Titanium Dioxide | 1.7 |
| Paraffin | 0.6 |
| Calcium carbonate | 0.4 |
| Bisphenol A | 0.4 |
| Silicon Dioxide | 0.2 |
| Aluminum Oxide | 0.1 |
| Other | 0.1 |

| Material | Content (%) |
|---|---|
| Wood flour | 75-80 |
| Melamine resin | 8-12 |
| Water | 4-6 |
| Epoxy resin | 1-3 |
| Titanium Dioxide | 1-2 |
| Paraffin | 0.5-1 |
| Calcium carbonate | 0.1-8 |
| Bisphenol A | 0.1-0.5 |
| Silicon Dioxide | 0.1-0.5 |
| Aluminium Oxide | 0.1-0.5 |
| Other | 0.1-0.5 |

At least part of the natural fibers is preferably entangled and/or intertwined within the core layer. It is for example possible that at least part of the natural fibers is present in a web-like structure within the core layer. The natural fibers may form a reinforcing network within the core layer which can also be referred to as an interconnected matrix, lattice or network.

In an embodiment of this invention, the natural fibers in the core layer are in the form of cellulose fibers, fibrous networks, cellulose layers, or fibrillated cellulose such as microfibrillated cellulose (MFC), or a nanofibrillated cellulose (NFC). These MFC and NFC have smaller diameters that fit well in the close-packed structure of the mineral materials in the core layer which then contributes to the formation of a dense uniform microstructure. The incorporation of cellulose fibers such as MFC and NFC into the mineral material or a concrete matrix, for example, provides a good balance of mechanical and physical properties resulting in a stable panel suitable for flooring. Moreover, cellulose fibers have close spacing between the fibers that are also effective in fracture toughness and crack suppression. To achieve this, it is preferred to provide between 1-30 wt. % fibrillated cellulose (MFC and/or NFC) to the core layer, based on total weight of the core layer.

In some embodiments, the fibrillated cellulose, such as microfibrillated cellulose (MFC), and/or nanofibrillated cellulose (NFC), comprises recycled material and/or a lignocellulosic fibrous material such as recycled pulp obtained from a chemical, mechanical, thermal, or combinations of the said processes. The microfibrillated cellulose comprises a reinforcing fiber geometry made of longer and thinner fibers that increase the tensile strength of the MFC due to the maximized aspect ratio. The longer fibers increase the connections between the individual fibers resulting in a distributed stress over a large area. In some embodiments, the fibers of the MFC are overlapping in a reinforcing manner similar to a mesh configuration. This then provides macroscopic stiffness and strength contributing to the panels' overall mechanical properties.

In some embodiments, the microfibrillated cellulose (MFC) or nanofibrillated cellulose (NFC) may comprise of one or more inorganic materials which may have been added during the processing of the MFC or NFC. The inorganic materials can be calcium carbonate, magnesium carbonate, kaolin, clay, or other similar materials in an amount of at least 1%, preferably directly proportional to the amount of MFC or NFC. The addition of the said inorganic materials enhance one or more mechanical properties of the panel.

In another embodiment, the panel having the microfibrillated cellulose (MFC) or nanofibrillated cellulose (NFC) may have a flexural strength of at least 300 Mpa, preferably at least 3,500 Mpa, most preferably at least 4,000 Mpa when tested according to EN 310. In another exemplary embodiment, the MFC has a d50 ranging from 5 to 500 microns. In yet another embodiment, the MFC has a modal fiber particle size ranging from about 0.1-500 microns.

In some further embodiments, at least one natural material can also be referred to as a biofiber comprising a fiber derived of biological origin, whether produced naturally or via a regenerated process. Preferably, the type of the natural material is selected from at least one pulp materials, at least one fibrous material, at least one non-wood fibrous material, at least one agro-fiber material, at least one bamboo species, at least one kraft material, or combinations, or derivatives thereof.

Most preferably, the at least part of the natural fibers comprises at least one natural material chosen from the group comprising of, but is not limited to, Abaca, Hemp, Hemp bast, Hesperaloe changii, Seed flax, Cotton, Hesperaloe funifera, Eucalyptus, Kenaf, Kenaf bast, Sisal, Yucca elata, Albardine (Lygeum spartum), Ceiba, kapok tree (Ceiba pentandra), Paper-mulberry (Broussonetia papyrifera), Ramie (Boehmeria nivea), Raphia (Raphia hookeri), Sabai (Eulaliopsis binata), Sidal (Agava sislana), Sunn (Crotaria juncea), Common reed (Phragmites communis), Cotton lint (Gossypium spp.), Flax (Linum usitatissimum), Jute (Corchrous caspsularis), Kenaf (Hibiscus cannabinus), Coir, Esparto, Arundo donax, their waste and/or byproducts, or combinations thereof.

Preferably, the at least part of the natural fibers comprises at least one natural material from the group comprising of, but is not limited to, Northern Hardwood Kraft (NHWK or NBHK), Northern Softwood Kraft (NSWK or NBSK), Softwood, Southern Softwood Kraft (SSWK), West Coast Softwood Kraft (WCSK), Coniferous wood, Deciduous wood, hardwood, Bamboo, their waste and/or byproducts, or combinations thereof.

Preferably, the at least part of the natural fibers comprises at least one natural material chosen from the group comprising of, but is not limited to, Wheat (Triticum sativum), Cereal straw, Corn straw, Wheat straw, rice straw, Sugar cane (Sacchrum officiarum), Rice (Oryza sativa), Sugar cane, bagasse, sorghum stalks, Corn (Zea mays), their waste and/or byproducts, or combinations thereof.

Preferably, the at least one natural material has a cellulose percentage in the range of 26 to 90 wt %, preferably in the range of 35 to 80 wt %, more preferably in the range of 40 to 70 wt % and/or at least one natural material has a lignin percentage in the range of 0.7 to 45 wt %, preferably in the range of 1 to 30 wt %, more preferably in the range of 2 to 20 wt %.

Preferably, the core layer comprises at least one binder to further aid in the coupling of the core layer materials. Hence, at least one core layer preferably comprises at least one binder, preferably a melamine, polyurethane, bio-PUR, phenol and/or acrylic-based binder.

At least one binder is preferably a polymeric binder chosen but is not limited to, thermoplastic or thermoset resins including but not limited to vinyl, polyvinyl chloride (PVC), polyethylene (PE), polyurethane (PU), acrylonitrile butadiene styrene (ABS), polyethylene terephthalate (PET), polybutylene terephthalate (PBT), polytrimethylene terephthalate (PTT), polyethylene naphthalate (PEN), polyethylene terephthalate glycol (PETg), and/or polypropylene (PP). It is likewise a possibility that the at least one binder may also comprise a polyamine such as melamine, triamine, and/or encumbered (poly)amine. The at least one binder may also comprise a melamine urea formaldehyde resin, and/or melamine formaldehyde resin. It is likewise conceivable that the at least one binder may also comprise a melamine formaldehyde resin.

At least one core layer preferably comprises in the range of 15 wt. % to 40 wt. % of at least one binder, preferably in the range of 20% to 30 wt. %, more preferably in the range of 22 wt. % to 28 wt. %, based on total weight of the core layer. In a possible embodiment, at least one core layer further comprises at least one additional filler selected from the group consisting of steel, glass, polypropylene (PP), wood, acrylic, alumina, curaua, carbon, cellulose, coconut, Kevlar, Nylon, perlon, polyethylene (PE), polyvinyl acetate (PVA), rock wool, viburnum and fique. This addition of the said fillers further increases the strength of the panel or may add other properties to the panel such as water resistance and/or fire resistance. Preferably, other filler materials can be added to the core layer such as organic materials like mycelium to reduce the overall weight of the panel.

In a preferred embodiment, at least two opposite side edges of the core layer are provided with a chamfer. It is for example conceivable that the panel comprises at least two chamfers, wherein a first chamfer is provided at a first side edge of the panel and a second chamfer is provided at a second side edge which opposes said first side edge, wherein each chamfer extends through at least part of the decorative top layer, and/or the coating layer if applied, and/or through at least part of the core layer. Where it is referred to a chamfer also a bevel, rounded bevel, or beveled edge can be meant. In another preferred embodiment, the angle at which the chamfer(s) provides the best visual effect ranges from 2 degrees to 30 degrees, more preferably from 4 to 15 degrees and even more preferably 6 to 9 degrees. The depth of the chamfer can for example range from 0.1 mm to 0.55 mm, in particular from 0.2 mm to 0.35 mm, and more in particular from 0.5 mm to 3 mm, and even more in particular from 1.5 mm to 2.5 mm. Said preferred ranges are found to the beneficial for the visual effect, especially but not necessarily, in combination with abovementioned viscosity and/or load ranges.

In a preferred embodiment of the panel, at least part of the bottom surface of the core layer is provided with a plurality of cavities. A plurality of cavities may further contribute to enhancing the acoustic performance of the panel. It is for example possible that the cavities are provided such that the (predetermined) pattern of cavities influences the acoustic properties, and in particular the sound dampening properties, of the panel. For such embodiment, typically at least one cavity extends in at least two directions within the same (horizontal plane). This may for example be the x- and z-direction, considering the cavity extends from the bottom surface towards the top surface of the core in the y-direction. At least one cavity may for example extend in at least two directions within a plane defined by the bottom surface of the core layer. Possibly, at least one cavity may extend in a direction other than the longitudinal direction of the panel in case the panel is substantially longitudinal. It is for example conceivable that the cavities extend in a combination of longitudinal and lateral directions. It is also conceivable that at least one, or all cavities, is/are substantially centrally positioned in the panel and/or do not extend through the (outer) edges of the panel. It is further conceivable that the cavities are positioned at a predetermined distance from another. It is also possible that the cavities form a network of interconnected cavities. This embodiment may in particular be beneficial as sound waves may travel through such interconnected cavities that sound travels through. The sound wave may lose its energy through friction between the air particles and the walls of the cavities where it is passing through. At least one outer edge and preferably all outer edges of the panel may be free of cavities. Hence, it is conceivable that the cavity or cavities do not extend through the outer edge(s) of the panel. It is for example conceivable that at least 1 cm from each outer edge of the panel is free of cavities. In a further preferred embodiment, the planar surface area of the bottom surface of the core layer is at least 30% less than the planar surface area of the top surface of the core layer. It is experimentally found that this difference further contributes to the acoustic performance of the panel whilst not affecting the rigidity and/or stability of the panel. The top surface of the core layer is typically substantially even and free of cavities. It is possible that at least one cavity has a substantially curvilinear geometric cross section. This may be a cross section of the panel seen from a perpendicular direction with respect to a plane defined by the bottom surface of the core layer. This may further contribute to the desired absorption, transmission, reflection, refraction and/or the diffraction of sounds waves interacting with the panel. It is also possible that at least one cavity has a substantially curvilinear geometric shape within a plane defined by the bottom surface. Such shape may also contribute to the sound distribution within the material. It is further conceivable that part of the core layer which encloses a cavity has a structured surface. It is for example possible that the surface of the core layer enclosing the cavity is at least partially structured. This may also be a profiled or rough surface. Hence, the core layer may be partially provided with a profiled surface, preferably near or at the area defining a cavity. The cavity may for example be a substantially elongated cavity. It is further conceivable that at least part of at least one cavity is substantially cylindrical, pyramidical and/or conical. At least part of a cavity may for example be formed by a substantially half cylinder, in particular in a plane of the bottom surface. The depth of at least one cavity may vary over the length and/or width of the cavity. In particular, the shape of the cavities is to be chosen such that they provide enhanced dissipation of impact and/or airborne sound. Preferably, the geometric shape of at least one, and preferably all cavities, in the bottom surface of the core layer do not induce a difference in length- or crosswise flexibility. Hence, the geometric shape of the cavity or cavities is chosen such that it they do not negatively influence the rigidity of the panel.

In a further preferred embodiment, at least one cavity may be at least partially filled with a filler material such as sound absorbing material and/or soundproofing material. This may further contribute to the sound absorbing character of the panel, and thus to the acoustic properties thereof. The sound absorbing material may for example be a natural material, such as bamboo, coco fibers and/or cork. Further non-limiting examples of sound absorbing material which could be used for the present invention are mineral wool, fiberglass, and/or polystyrene foam. In a further possible embodiment, at least one cavity may be substantially completely filled with sound absorbing material.

The panel may further comprise at least one reinforcement layer. Non-limiting examples of such reinforcement layer are fiber glass, polypropylene, jute, cotton and/or polyethylene terephthalate. It is in particular beneficial if the reinforcement layer is at least partially impregnated with a thermosetting resin. Such thermosetting resin may be selected from the group comprising of: melamine formaldehyde resin, phenolic resins and/or urea formaldehyde. Typically, a reinforcement layer, if applied, is present near the top surface and/or near the bottom surface of the panel. In particular, the reinforcement layer is attached to core layer. It is also conceivable that at least one reinforcement layer is embedded within the core layer.

In another preferred embodiment of the panel according to the invention, the panel comprises at least one pair, and preferably two pairs, of opposite side edges which are provided with interconnecting coupling means for interconnecting one panel with another. Preferably, the said interconnecting coupling means are integrated in the core layer. Typically, at least one pair of opposite side edges of the core layer is provided with complementary coupling parts. For example, the core layer comprises at least one pair of complementary coupling parts on at least two of its opposite side edges. Said coupling parts may for example be interlocking coupling parts configured for mutual coupling of adjacent panels on multiple directions. Preferably, said interlocking coupling parts provide locking in both horizontal and vertical directions. Any suitable interlocking coupling parts as known in the art could be applied. For example, said interlocking coupling parts may be in the form of complementary tongue and groove, male and female receiving parts, a projecting strip and a recess configured to receive said strip or any other suitable form. It is conceivable the complementary coupling parts require a downward scissoring motion when engaging or are locked together by means of a horizontal movement. It is further conceivable that the interconnecting coupling mechanism comprises a tongue and a groove wherein the tongue is provided on one side edge of one pair of opposite side edges, and the groove is provided on the other side edge, or an adjacent side relative to that of the tongue, of the same pair of opposite side edges. Such design of coupling mechanism is well-known in the art and has proven highly suitable for panels for floor coverings such as a floating floor. In a further embodiment it is possible that the interconnecting coupling mechanism has an interlocking feature which prevents interconnected panels from any free movement (play). Such an interlocking feature may be a projection and a respective recess provided on the respective opposite side edges by which neighboring panels interlock with each other. It is conceivable for provisions of reinforcement in the interlocking coupling parts to improve strength and prevent breakage thereof during installation of the panels. For example, the complementary or interlocking coupling parts may be reinforced with materials such as but not limited to fiberglass mesh, reinforcing sheets, carbon fibers, carbon nanotubes, ceramics, glass, arrays of metallic or non-metallic rods, or polymer compounds integrally formed in the core layer. It is also conceivable that a wax layer or a strengthening coating layer of micro or nanotechnology is added on the surface of the interlocking coupling parts to further achieve water resistance or further prevent damages to the interlocking coupling parts. The panel according to the present invention and/or the panel obtained via the method according to the present invention is suitable for use in flooring, wall or ceiling coverings preferably featuring a locking mechanism. As such a ‘floating’ covering can be assembled by interconnecting the individual panels with each other at all four sides, without the need for adhesives.

In another exemplary embodiment of the present invention, it is conceivable to treat at least part of the side edges of the panel, preferably the interlocking mechanism provided thereunto, with at least one water-repellent composition comprising a fluorinated polymer or copolymer. Said coating material is preferably a fluoroacrylate polymer with the following formula:

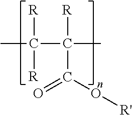

wherein one or more of the R groups are fluorine atoms, and the other R groups are hydrogen atoms. Herein, the R group is preferably free of hydrogen atoms, and preferably chosen from the list consisting of sodium, potassium, CF₃.

It is conceivable that said water-repellent composition comprises a fluorine-free durable water repellent (DWRs) chosen from the group of hydrocarbons, long-chain fatty acids, silicone-based DWR, and inorganic nanoparticles such as fullerenes, silica fume, cerium oxide nanoparticles, titanium dioxide nanoparticles, zinc oxide nanoparticles, polyacrylate, paraffin, isocyanates, polysiloxanes, polyamines, and/or a combination thereof. In an exemplary embodiment which shows particular synergy with the panel according to the present invention, said fluorine-free durable water repellent composition may also comprise at least one polyacrylate obtained by polymerizing at least two (meth)acrylates at a weight % of 10-80% of said water repellent composition, at least one paraffin at a weight % of 10-80%, and optionally at least one isocyanate, preferably an encumbered isocyanate, an organic polysiloxane, and/or a melamine resin at a weight % of 1-30% of said composition. Said water repellent substance further comprises water and/or an organic solvent at a weight % of 1-50% at the time of application. The water-repellent mechanism of said composition may be achieved through the combined action of at least two components. It is conceivable that said polyacrylate and paraffin components provide hydrophobicity to the composition, while the optional isocyanate component may crosslink said polyacrylate and paraffin components, enhancing the durability of the water-repellent composition. The optional organic polysiloxane component imparts softness and flexibility to the composition, while the optional melamine component improves the adhesion of the composition to the core or panel according to the invention. In one possible embodiment, said optional polysiloxane comprises an amino-modified silicone, a silicone resin, and/or an alkylpolysiloxane.

The panel according to the present invention preferably has a rigidity (MOR) in the range of 40 to 80 MPa, in particular in the range of 50 to 70 MPa, more in particular substantially 60 MPa. Such embodiment ensures a sufficient dimensional stability and toughness of the panel.

According to the embodiments of this invention, the optional backing layer can be adhered on the bottom surface of the core layer via an adhesive. The backing layer preferably comprises one or more polymer materials, for example, but not limited to polyvinyl chloride (PVC), polystyrene (PS), polyethylene (PE), polyurethane (PU), acrylonitrile butadiene styrene (ABS), polypropylene (PP), polyethylene terephthalate (PET), or combinations thereof. The backing layer may also be a sound absorbing layer. Such sound absorbing backing layer may further contribute to the good acoustic properties of the panel. Such backing layer may also be referred to as an acoustic layer. The backing layer may be composed of a foamed layer, preferably a low-density foamed layer, of ethylene-vinyl acetate (EVA), irradiation-crosslinked polyethylene (IXPE), expanded polypropylene (XPP) and/or expanded polystyrene (XPS). It is also conceivable that the backing layer comprises nonwoven fibers such as natural fibers like hemp or cork, and/or recycled/recyclable material such as PET. The backing layer preferably has a density between 65 kg/m³ and 300 kg/m³, most preferably between 80 kg/m³ and 150 kg/m³.

The panel could optionally comprise the at least one coating layer configured to provide protection to the topmost portion of the panel, comprising a thermoplastic or thermosetting resin. Non-limiting examples of thermoplastic or thermosetting materials which could be used are polyvinyl chloride (PVC), polystyrene (PS), polyethylene (PE), polyurethane (PU), acrylonitrile butadiene styrene (ABS), polypropylene (PP), polyethylene terephthalate (PET), phenolic and/or melamine or formaldehyde resins. In a preferred embodiment, the coating layer can for example be a polyurethane coating, a PUR coating, an at least partially bio-based PUR coating, an acrylic coating, and/or an epoxy polyol coating. According to another embodiment of the present invention, the at least one coating layer, if applied, may further comprise abrasion resistant materials in order to improve the wear resistance thereof and/or slip resistant particles, and/or combinations of both. Non-limiting examples of said abrasive resistant materials and/or slip resistant particles are: aluminum oxide, quartz, silica, silicon dioxide, titanium dioxide, corundum, carborundum, silicon carbide, glass, glass beads, glass spheres, diamond particles, hard plastics, reinforced polymers and organics, combination thereof, or other alternative particles with a high Mohs hardness such as diamond particles, and the like. In a further embodiment, the at least one coating layer, if applied, further comprises antimicrobial, antivirus (si-quat), antibacterial, anti-fungus agents. As such, the coating layer may further comprise an antimicrobial agent that can be incorporated therein before the curing step. The antimicrobial agent embedded in the coating layer, if applied, is conceived to be able to inhibit the emergence and/or growth of microbes such as fungus, bacteria (i.e. gram positive and gram negative bacteria such as Staphylococcus aureus, Kleibsella pneumoniae and Salmonella and the like), yeast and other pathogens including nonpathogens on the surface of the floor panel. It is conceivable that the antimicrobial agent may be organic or inorganic, preferably non-toxic and without heavy metals. The antimicrobial agent may be selected from the group consisting of quaternary ammonium compounds, sesquiterpene alcohols, halogenated phenyl ethers, halogenated carbanilides, halogenated salicylanilides, bisphenolic compounds, general phenols, formaldehyde, pyridine derivatives and hexachlorophene. The aforementioned antimicrobial agents are preferred over disinfectants such as iodine and complexes thereof as these are highly pigmented and may cause detrimental effects to the chemical, mechanical and physical properties of the coating layer, specially to the transparency/clarity of the coating layer which is desired in order to conserve the aesthetics of the panel. The antimicrobial agent, if applied, is preferably present in the coating layer from about 0.05% to about 5% by weight, preferably from about 0.070% to about 3.5%, more preferably from about 0.080% to about 3%. It is experimentally found that said amount of antimicrobial agent in the coating layer is able to survive crosslinking/polymerization during the curing process, or in other words is not destroyed during curing, without causing undesirable effects to the chemical, mechanical and physical properties of the coating layer. Said amount of antimicrobial agent in the coating layer is also experimentally found to last the lifetime of the coating layer while also being sufficient to inhibit the formation and/or growth of microbes. The coating layer, in particular the upper coating surface of the coating layer, preferably has a Shore D hardness of at least 85 or preferably be in the range of 90 to 95. Good experimental results were obtained for a coating layer having a hardness in the mentioned range in combination with a substrate according to the present invention. In a preferred embodiment, the coating layer comprises a plurality of microstructures providing a matte, super matte, ultra-matte, or low gloss finish on the top surface of the panel wherein the microstructures are obtained either via embossing, digital printing, UV curing, excimer curing, irradiation, or combinations thereof.

In one possible embodiment, the decorative top layer is basically composed of a carrier material layer designed to be provided with a decorative pattern at the upper side. A suitable material is a woven, extruded or calendered plastic net, sheet or film. Non-limiting examples of thermoplastic or thermosetting materials which could be used are polyvinyl chloride (PVC), polystyrene (PS), polyethylene (PE), polyurethane (PU), acrylonitrile butadiene styrene (ABS), polypropylene (PP), PET, PETg, phenolic and/or melamine or formaldehyde resins.

Alternatively, the decorative top layer may comprise at least one cellulose based layer and possibly a cured resin, wherein the cellulose based layer is preferably paper, a wood veneer, a bamboo veneer, and the like. Such a decorative layer can comprise a multitude of such plies of resin impregnated paper or wood veneers.

In a preferred embodiment, the top layer comprises at least one substantially transparent wear layer or protective finish. The wear layer may comprise one or more transparent layers of a thermoplastic or thermosetting resin. Non-limiting examples of thermoplastic or thermosetting materials which could be used are polyvinyl chloride (PVC), polystyrene (PS), polyethylene (PE), polyurethane (PU), acrylonitrile butadiene styrene (ABS), polypropylene (PP), polyethylene terephthalate (PET), PETg, PUR, bio-based PUR, phenolic and/or melamine or formaldehyde resins. Said wear layer may also be in a liquid or paste-like form made of a thermosetting resin such as, but not limited to, phenolic and/or melamine or formaldehyde resins and/or a reactive resin such as PUR and/or bio-based PUR. The wear layer may comprise or may be substantially composed of an inherently scratch-resistant thermosetting resin impregnating a carrier layer such as paper or lignocellulose. An advantage of this latter embodiment is that the urea-formaldehyde also acts as a relatively scratch-resistant wear layer.

Typically, a preferred thickness of the wear layer structure in the panel of the invention is in the range of 0.1 to 2.0 mm, more preferably between 0.15 mm to 1 mm and most preferably between 0.2 mm to 0.8 mm. It is conceivable that the wear layer has a larger thickness than the décor layer. It is for example possible that at least one wear layer has a thickness of about 0.15 to 1 mm. The total thickness of the decorative top layer is in that embodiment typically between 0.17 to 1.07 mm. Said at least one wear layer may for example cover partly the upper surface of the decorative layer, more preferably at least 50% of said upper surface of the decorative layer is covered, and most preferably, said at least one wear layer covers the entirety of the upper surface of the decorative layer.

It is conceivable that said at least one wear layer may further comprise abrasive materials in order to improve the wear resistance thereof. Non-limiting examples of said abrasive materials are: aluminum oxide such as quartz, silica, corundum, carborundum, silicon carbide, glass, glass beads, glass spheres, diamond particles, hard plastics, reinforced polymers and organics, or a combination thereof.

At least one wear layer can for example be based on any thermoplastic or thermosetting material. The wear layer may further comprise a filler, for example based on calcium, carbonate or magnesium.

It is contemplated for embodiments described herein to extend to individual elements and concepts described herein, independently of other concepts, ideas or system, as well as for embodiments to include combinations of elements recited anywhere in this application. It is to be understood that the invention is not limited to the embodiments described in detail herein with reference to the accompanying drawings. As such, many variations and modifications will be apparent to practitioners skilled in this art. Illustrative embodiments such as those depicted refer to a preferred form but is not limited to its constraints and is subject to modification and alternative forms. Accordingly, it is intended that the scope of the invention be defined by the following claims and their equivalents. Moreover, it is contemplated that a feature described either individually or as part of an embodiment may be combined with other individually described features, or parts of other embodiments, even if the other features and embodiments make no mention of the said feature. Hence, the absence of describing combinations should not preclude the inventor from claiming rights to such combinations.

The invention further relates to a method for producing a panel, in particular a floor, wall or ceiling panel, preferably according to the present invention, comprising the steps of:
a) providing a composition comprising in the range of 50 wt % to 70 wt % natural fibers, wherein at least 40 wt % and preferably at least 50 wt % of said natural fibers has an average fiber length of at least 4 mm;
b) subjecting the composition to a force having a pressure in particular of at least 7 MPa such that a core layer is obtained; and optionally
c) providing at least one decorative top layer to the upper core surface of the core layer, preferably by applying heat and/or pressure.

In step a), as an alternative, the composition may comprise 1 wt % to 30 wt % of microfibrillated cellulose fibrils based on total weight of the composition, instead of comprising the natural fibers. The composition may also comprise 1 wt % to 30 wt % of microfibrillated cellulose fibrils based on total weight of the composition, in addition to comprising the natural fibers.

Additionally or alternatively the present invention may provide a method for producing a panel, in particular a floor, wall or ceiling panel, preferably according to any of claims 1-38, comprising the steps of:
a) providing a composition comprising 1 wt % to 30 wt % of microfibrillated cellulose fibrils based on total weight of the composition, and/or comprising 50 wt % to 70 wt % cellulose fibers, wherein at least 40 wt % and preferably at least 50 wt % of the cellulose fibers have an average fiber length of at least 4 mm;
b) subjecting the composition to a force having a pressure in particular of at least 7 MPa such that a core layer is obtained; and optionally
c) attaching at least one decorative top layer to the upper core surface of the layer, preferably by applying heat and/or pressure.

According to an exemplary embodiment of the present invention, at least part of the natural fibers are optionally subjected to an alkaline pretreatment prior to step b). Said alkaline pretreatment may comprise immersing, combining and/or boiling at least part of said natural fibers in a solution of sodium hydroxide (NaOH) and/or sodium sulfite (Na₂SO₃).

It is conceivable that the alkaline pretreatment aids in at least partially removing and/or degrading hemicellulose, lignocellulose, and/or lignins present in said natural fibers, conceivably rendering at least some natural fibers, specifically the cell walls comprised in said fibers, able to at least partially collapse when subjected to pressure. It is within the scope of the present invention that an incomplete reduction of hemicellulose and/or lignin provides synergistic effects on the core layer, advantageously allowing the creation of hydrogen-bonding or recombination between the fibers, specifically during step b) and/or step c), further strengthening the properties of the core layer and/or panel according the invention

It is further conceivable that the alkaline pretreatment further comprises immersion of at least part of the fibers in a water bath and/or interrupted or intermittent heating. It is noted that the at least partial degradation of hemicellulose and/or lignin during said alkaline pretreatment, resulting in at least partial recombination of fibers during step b) and/or step c), results in an increased density, and an increased rigidity and/or strength of the core layer. It is inferred that the degradation of hemicellulose and/or lignin results in the recombination of cellulose microstructure and/or an increase in cellulose crystallinity. It is further conceivable that saccharic acids are generated through the reducing terminal group of polysaccharides in the alkaline environment. Moreover, new chromophoric groups may be polymerized by said saccharic acids. In addition, lignin may also be subjected to diarylation and dealkylation reaction with both nucleophile SO₃²⁻ and OH⁻ ions in said alkaline pretreatment, further producing chromophoric groups, such as quinone, epoxide, or lignosulphonates. It is therefore inferred that the degradation of hemicellulose, lignin and/or lignocellulose resulted in the recombination of cellulose microstructure and finally caused the increase in cellulose crystallinity, thereby imparting improved rigidity. The resulting core layer is further water resistant, has a low water swelling rate, and is conceivably or substantially a waterproof layer.

In an exemplary embodiment, said pretreated natural fibers comprise less than 20% by weight, more preferably less than 10% by weight of hemicellulose and/or less than 30% by weight, more preferably less than 15% by weight of lignin. It is preferable that at least part of the natural fibers, in particular MFC, may have an alkaline steeping value of equal to or less than about 20 wt. % aq. NaOH at 20-50° C. The MFC may have a steeping value equal to or less than about 20 wt. % aq. NaOH at 20-50° C., or equal to or less than about 18 wt. % aq. NaOH at 20-50° C., or equal to or less than about 20 wt. % aq. NaOH at 20-50° C., or equal to or less than about 10 wt. % aq. NaOH at 20-50° C.

It is conceivable that the alkaline pretreatment step leads at least partially to a relatively higher degree of alignment of natural fibres, thereby increasing their interfacial area. It is possible that hydrogen-bond formation between adjacent fibers, owing to the rich hydroxyl groups in cellulose molecular chains, reduces the ability of the natural fibers to move, take up moisture, and/or deform, producing a much higher strength than untreated wood fibers. Further, hydrogen bonds formed between neighbouring cellulose fibres make a pivotal contribution to the remarkably enhanced strength and toughness. It is conceivable that the at least one alkaline pretreatment is followed by at least one shearing step to at least partially form fibrils, more preferably at least partially longer fibrils, such that the partially longer fibrils can further act as fortified natural anchors or entanglement-enabling mechanism in the core layer, which has a further positive effect on both the shrinking rate, swelling rate and strength of the panel.

It is a possibility that the alkaline pretreated wood fibers are subject to resin impregnation comprising of melamine formaldehyde resin. It is a further possibility that the sheared fibrils are subject to impregnation with melamine formaldehyde (MF), melamine urea formaldehyde (MUF) resin, and/or a polyacrylic resin, and subsequently goes into a preferably continuous process of pressing and heating to at least partially remove water from the composition.

In another embodiment, the composition in step (a) further comprises at least one mineral filler. Preferably, the at least one mineral filler is selected from the group consisting of: minerals, preferably calcium carbonate, talc, dolomite, calcite; and pigments, modifiers, fibers, such as: glass fiber, wood, straw and/or hemp. The fibers can be loose fibers and/or interconnected fibers to form a woven or nonwoven layer.

In yet another embodiment, prior to step a), the method further comprises an optional fiber processing step, wherein cellulose fibers are processed to form at least partially micro fibrillated cellulose (MFC) and/or nano fibrillated cellulose (NFC) fibrils. In particular, cellulose fibers are broken down into smaller fibrils, more particularly into micro- and/or nanofibrillated fibrils, which will be at least partially dispersed into the composition in step a). It has been found that the cellulose fibers having a higher aspect ratio (length-to-diameter ratio) compared to short cellulose fibers, exhibit easier processability, as they are more easily broken down and dispersed in the composition during step a) of the production process. It is conceivable that said optional fiber processing step is carried out at least partially by applying mechanical forces in order to carry out the breakdown of cellulose fibers into smaller fibrils with substantially uniform length and/or diameter. Particularly, optional fiber processing step is carried out using techniques such as sonication, high-pressure homogenization and/or microfluidization.

Furthermore, relatively long cellulose fibers, which have higher surface areas, appear to cause a considerable reduction in the amount of cellulose material used as a higher yield of MFC fibrils per unit of cellulose material is achieved which is advantageous from a cost perspective. In addition, it has been found that the network structure made from long MFC fibrils are significantly stronger when compared to that of short MFC fibrils. As a result, the mechanical properties of the core layer and the panel in whole is significantly improved.

In yet another embodiment, surface modification to the MFC fibrils is carried out to reduce the surface tension between MFC fibrils and thereby improve the dispersion and stability of MFC fibrils in the composition of step (a). The surface modification can be carried out using chemical treatments such as but not limited to the use of surfactants or other surface-active agents. In yet another embodiment, the MFC fibrils produced in said fiber processing step may be at least partially stabilized through the adjustment of the pH of the composition in step (a). It has been found that adjusting the pH of the composition in step (a), such that the MFC fibrils achieve a net charge which can repel each other and prevent them from aggregating or forming clumps, stabilize the MFC fibrils in the composition of step a). As a result, homogeneity of the dispersion of MFC fibrils in the composition of step a) is significantly improved.

In another embodiment, the composition in step a) further comprises PEI, chitosan and/or tannic acid which has been found to cross-link MFC fibrils thereby further improving the mechanical properties and stability of the core layer produced by the method of the present invention.

In an embodiment, the method comprises after step c) a step d) of applying an interlocking mechanism on at least one side edge, preferably on at least one, most preferably on at least two opposing side edges of the panel or the core layer, allowing for the panel to be installed in a floating manner. In line therewith, the method may comprise after step d) a step e) of providing a water repellent composition, preferably a fluorine-free durable water repellent on at least part of the surface of said interlocking mechanism.

Any of the embodiments as described for the panel according to the present invention can be included in the corresponding method according to the present invention.

The invention will now be elucidated on the basis of the following non-limitative clauses.
1. A panel, such as a floor panel, wall panel, or a ceiling panel, comprising:
   at least one core layer; and
   at least one decorative top layer;
wherein at least one core layer comprises in the range of 50 wt % to 70 wt % natural fibers, wherein at least 40 wt % and preferably at least 50 wt % of said natural fibers has an average fiber length of at least 4 mm.
2. The panel according to clause 1, wherein at least part of the natural fibers are non-coniferous fibers, in particular non-coniferous fibers having an average fiber length of at least 4 mm.
3. The panel according to clause 2, wherein at least part of the non-coniferous fibers are chosen from the groups of abaca, hemp, hemp bast, Hesperaloe changii, seed flax, cotton, and/or Hesperaloe funifera.
4. The panel according to any of the previous clauses, wherein at least part of the natural fibers have an average length to diameter ratio of at least 100:1, preferably at least 135:1, more preferably at least 150:1.
5. The panel according to any of the previous clauses, wherein the panel, and in particular the core layer, has a swelling rate of less than 5%, more preferably less than 4%, most preferably less than 3% when tested according to ISO 24336/NALFA 3.2.
6. The panel according to any of the previous clauses, wherein the panel has a modulus of elasticity (MOE) in the range of 4000 to 8000 MPa in particular when tested according to EN 310 or ASTM D790.
7. The panel according to any of the previous clauses, wherein at least part of the natural fibers comprises at least one natural material chosen from the group comprising of Northern Hardwood Kraft (NHWK or NBHK), Northern Softwood Kraft (NSWK or NBSK), Softwood, Southern Softwood Kraft (SSWK), West Coast Softwood Kraft (WCSK), Abaca, Bamboo, Eucalyptus, Hemp bast, Hesperaloe changii, Hesperaloe funifera, Industrial Hemp, Kenaf bast, Yucca elata, or combinations thereof.
8. The panel according to any of the previous clauses, wherein at least part of the natural fibers comprises at least one natural material chosen from the group comprising of Abaca (Musa textilis), Albardine (Lygeum spartum), Bamboo (Dendrocalamus arundinacea), Ceiba, kapok tree (Ceiba pentandra), Common reed (Phragmites communis), Corn (Zea mays), Cotton lint (Gossypium spp.), Flax (Linum usitatissimum), Hemp (Cannabis sativa), Jute (Corchrous caspsularis), Kenaf (Hibiscus cannabinus), Paper-mulberry (Broussonetia papyrifera), Ramie (Boehmeria nivea), Raphia (Raphia hookeri), Rice (Oryza sativa), Sabai (Eulaliopsis binata), Sidal (Agava sislana), Sugar cane (Sacchrum officiarum), Sunn (Crotaria juncea), wheat (Triticum sativum), or combinations thereof.
9. The panel according to au of the previous clauses, wherein at least part of the natural fibers comprises at least one natural material chosen from the group comprising of abaca, bamboo, cereal straw, coir, coniferous wood, corn straw, cotton, deciduous wood, esparto, hemp, jute, kenaf, papyrus, rice straw, seed flax, sisal, sugar cane bagasse, wheat straw, or combinations thereof.
10. The panel according to any of the previous clauses, wherein at least part of the natural fibers comprises at least one natural material comprising at least one bamboo species chosen from the group comprising of Bambusa arundinacea (Dowga), Bambusa arundinaria, Bambusa blummeana, Bambusa vulgaris, Dendrocalamus strictus (Medar), Gigantochloa aspera, Monostigma oxygenanthera (Chiva), Phyllostachus bambusoides, Phyllostachys nigra, Schizostachyum lima, Schizostachyum lumampao, or combinations thereof.
11. The panel according to any of the previous clauses, wherein at least part of the natural fibers comprises at least one natural material comprising at least one kraft material chosen from the group comprising of Abaca, Arundo donax, Bagasse, Bamboo, Corn stalks, Hesperaloe changii, Hesperaloe funifera, Sorghum stalks, wheat straw, hardwood, or combinations thereof.
12. The panel according to any of clauses 3 and/or clause 7 to 11, wherein at least one natural material has a cellulose percentage in the range of 26 to 90 wt %, preferably in the range of 35 to 80 wt %, more preferably in the range of 40 to 70 wt %.
13. The panel according to any of clauses 3 and/or clause 7 to 12, wherein at least one natural material has a lignin percentage in the range of 0.7 to 45 wt %, preferably in the range of 1 to 30 wt %, more preferably in the range of 2 to 20 wt %.
14. The panel according to any of the previous clauses, wherein at least part of the natural fibers comprises an average fiber length in the range from 4 to 15 mm, preferably in the range from 4.1 to 10 mm, more preferably in the range from 4.5 to 7.5 mm.
15. The panel according to any of the previous clauses, wherein at least part of the natural fibers comprises an average coarseness value between 6 to 30 mg/100 m, preferably between 8 and 25 mg/100 m, more preferably between 10 and 20 mg/100 m.
16. The panel according to any of the previous clauses, wherein at least part of the natural fibers has an average diameter between 3 to 50 microns, preferably between 5 to 40 microns, more preferably between 7 to 30 microns.
17. The panel according to any of the previous clauses, wherein at least part of the natural fibers has an average fiber width in the range of 4 to 80 μm, preferably in the range of 7 to 60 μm, more preferably in the range of 8 to 40 μm.
18. The panel according to any of the previous clauses, wherein at least part of the natural fibers is subjected to a treatment chosen from irradiation treatment and/or surface treatment, in particular microwave treatment, infrared treatment, surface coating, cold treatment and/or heat treatment.
19. The panel according to any of the previous clauses, wherein at least part of the natural fibers are recycled natural fibers.
20. The panel according to any of the previous clauses, wherein at least part of the natural fibers are entangled and/or intertwined within the core layer.
21. The panel according to any of the previous clauses, wherein at least part of the natural fibers is present in a web-like structure within the core layer.
22. The panel according to any of the previous clauses, wherein at least part of the natural fibers is substantially elongated and/or at least partially round and/or rounded at the distal ends.
23. The panel according to any of the previous clauses, wherein the thickness of the panel, and in particular the thickness of the core layer is at most 6 mm, preferably at most 5 mm.
24. The panel according to any of the previous clauses, comprising at least one backing layer, in particular wherein the backing layer forms a sound attenuating barrier and covers at least part of the bottom surface of the bottom layer, wherein at least part of the sound attenuating barrier includes vibrating materials.
25. The panel according to any of the previous clauses, comprising at least one pair of opposing edges, said pair of opposing side edges comprising complementary coupling parts configured for mutual coupling of adjacent panels.
26. The panel according to any of the previous clauses, wherein at least one core layer comprises in the range of 0.1 to 20 wt % of at least one mineral material, preferably in the range of 0.2 to 10 wt %, more preferably in the range of 0.4 to 5 wt % or in the range of 0.4 to 4 wt %.
27. The panel according to any of the previous clauses, wherein at least one core layer comprises at least one mineral material selected from the group consisting of: magnesium oxide, magnesium chloride, magnesium sulfate, calcium carbonate, chalk, limestone, clay, calcium silicate and/or talc.
28. The panel according to any of the previous clauses, wherein the panel has a rigidity (MOR) in the range of 40 to 80 MPa, in particular in the range of 50 to 70 MPa, more in particular substantially 60 MPa.
29. The panel according to any of the previous clauses, wherein at least one core layer comprises at least one binder, preferably a melamine based binder.
30. A method for producing a panel, in particular a floor, wall or ceiling panel, preferably according to any of the previous clauses, comprising the steps of:
a) providing a composition comprising in the range of 50 wt % to 70 wt % natural fibers, wherein at least 40 wt % and preferably at least 50 wt % of said natural fibers has an average fiber length of at least 4 mm;
b) subjecting the composition to a force having a pressure in particular of at least 7 MPa such that a core layer is obtained; and
c) attaching at least one decorative top layer to the upper core surface of the layer, preferably by applying heat and/or pressure

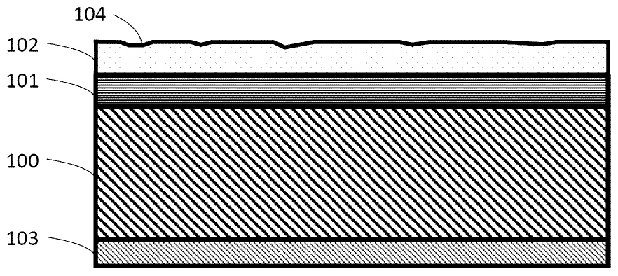

The invention will be further elucidated by means of non-limiting exemplary embodiments illustrated in the following figures, in which FIG. 1 shows a possible embodiment of a panel according to the present invention.

FIG. 1 is a schematic representation of a possible embodiment of a panel according to the present invention. The panel comprises a substrate or a core layer 100, a decorative top layer 101, an optionally at least one coating layer 102, and an optional backing layer 103. The decorative top layer 101 is provided on top of the core layer 100. The at least one coating layer 102 provided on the top surface of the decorative top layer 101. Optionally, a backing layer 103 is provided at the bottom part or bottom surface of the core layer 100. In the shown embodiment, the top surface of the coating layer 102 comprises embossing 104. The embossing 104 can be tactile features, impressed texture, depressions, or embossed portions. At least part of the embossing 104 can have a depth in the range of 0.05 to 0.4 mm. It is also conceivable that at least part of the embossing 104 has a depth of 0.1 to 0.2 mm and/or from 0.2 to 0.3 mm.

It will be clear that the invention is not limited to the exemplary embodiments which are illustrated and described here, but that countless variants are possible within the framework of the attached claims, which will be obvious to the person skilled in the art. In this case, it is conceivable for different inventive concepts and/or technical measures of the above-described variant embodiments to be completely or partly combined without departing from the inventive idea described in the attached claims.

The verb ‘comprise’ and its conjugations as used in this patent document are understood to mean not only ‘comprise’, but to also include the expressions ‘contain’, ‘substantially contain’, ‘formed by’ and conjugations thereof.

1. A panel, such as a floor panel, wall panel, or a ceiling panel, comprising:
at least one core layer; and
at least one decorative top layer;
wherein at least one core layer comprises 1 wt % to 30 wt % of microfibrillated cellulose fibrils based on total weight of the at least one core layer, and
wherein an average fibril length of the microfibrillated cellulose fibrils is at least 10 micrometers.

2. The panel according to claim 1, wherein the microfibrillated cellulose fibrils form natural anchors or entanglement-enabling mechanisms in the at least one core layer.

3. The panel according to claim 1, wherein the average fibril length of the microfibrillated cellulose fibrils is at least 100 micrometers, preferably at least 300 micrometers.

4. The panel according to claim 1, wherein an average fibril diameter of the microfibrillated cellulose fibrils is at most 50 nanometers, more preferably at most 20 nanometers, most preferably at most 10 nanometers.

5. The panel according to claim 1, wherein the at least one core layer further comprises 20 wt % to 70 wt % of cellulose fibers, based on total weight of core layer, wherein at least 20 wt %, and preferably at least 50 wt % of the cellulose fibers, based on total weight of the cellulose fibers, has an average fiber length of at least 4 mm.

6. The panel according to claim 1, wherein the microfibrillated cellulose fibrils and/or cellulose fibers form interconnected structures, optionally wherein the interconnected structures have a branching or dendritic appearance or wherein the interconnected structures are three-dimensional structures that resemble the branches of a tree or the dendrites of a neuron.

7. The panel according to claim 1, wherein the core layer comprises 70 wt. % to 99 wt. % of at least one inorganic material comprising at least one mineral and/or at least one ceramic material, based on total weight of the core layer.

8. The panel according to claim 1, wherein the core layer comprises cross-linking agents selected from polyethyleneimine, chitosan and/or tannic acid.

9. The panel according to claim 1, wherein the panel has a swelling rate of less than 5%, more preferably less than 4%, most preferably less than 3% when tested according to ISO 24336/NALFA 3.2.

10. The panel according to claim 1, wherein the at least one core layer of the panel has an ash content of less than 10 wt. %, more preferably less than 7 wt. %, most preferably less than 5 wt. %, preferably according to ASTM D1102 based on total weight of the core layer.

11. The panel according to claim 1, wherein the at least one core layer of the panel has a shrinking rate of less than 5%, most preferably less than 3%.

12. The panel according to claim 1, wherein at least part of the cellulose fibers are non-coniferous fibers, in particular non-coniferous fibers having an average fiber length of at least 4 mm.

13. The panel according to claim 12, wherein the non-coniferous fibers are chosen from abaca, hemp, hemp bast, Hesperaloe changii, seed flax, cotton, Hesperaloe funifera, or any combination thereof.

14. The panel according to claim 1, wherein at least part of the microfibrillated cellulose fibrils and/or at least part of the cellulose fibers have an average length to average diameter ratio of at least 100:1, preferably at least 135:1, more preferably at least 150:1.

15. The panel according to claim 1, wherein the panel has a modulus of elasticity (MOE) in the range of 4000 to 8000 MPa in particular when tested according to EN 310 or ASTM D790.

16. The panel according to claim 1, wherein at least part of the microfibrillated cellulose fibrils and/or the cellulose fibers comprise at least one natural material chosen from at least one pulp material, at least one fibrous material, at least one non-wood fibrous material, at least one agro-fiber material, at least one bamboo species, at least one kraft material, or any combination or derivative thereof.

17. The panel according to claim 1, wherein at least part of the microfibrillated cellulose fibrils and/or at least part of the cellulose fibers comprise at least one natural material chosen from Abaca, Hemp, Hemp bast, Hesperaloe changii, Seed flax, Cotton, Hesperaloe funifera, Eucalyptus, Kenaf, Kenaf bast, Sisal, Yucca elata, Albardine (Lygeum spartum), Ceiba, kapok tree (Ceiba pentandra), Paper-mulberry (Broussonetia papyrifera), Ramie (Boehmeria nivea), Raphia (Raphia hookeri), Sabai (Eulaliopsis binata), Sidal (Agava sislana), Sunn (Crotaria juncea), Common reed (Phragmites communis), Cotton lint (Gossypium spp.), Flax (Linum usitatissimum), Jute (Corchrous caspsularis), Kenaf (Hibiscus cannabinus), Coir, Esparto, Arundo donax, or any combination, waste, and/or byproduct thereof.

18. The panel according to claim 1, wherein at least part of the microfibrillated cellulose fibrils and/or at least part of the cellulose fibers comprises at least one natural material chosen from Northern Hardwood Kraft (NHWK or NBHK), Northern Softwood Kraft (NSWK or NBSK), Softwood, Southern Softwood Kraft (SSWK), West Coast Softwood Kraft (WCSK), Coniferous wood, Deciduous wood, hardwood, Bamboo, or any combination, waste, and/or byproduct thereof.

19. The panel according to claim 1, wherein at least part of the microfibrillated cellulose fibrils and/or at least part of the cellulose fibers comprise at least one natural material chosen from Wheat (Triticum sativum), Cereal straw, Corn straw, Wheat straw, rice straw, Sugar cane (Sacchrum officiarum), Rice (Oryza sativa), Sugar cane, bagasse, sorghum stalks, Corn (Zea mays), or any combination, waste, and/or byproduct thereof.

20-38. (canceled)

39. A method for producing a panel, in particular a floor, wall or ceiling panel, preferably according to claim 1, comprising the steps of:
a) providing a composition comprising 1 wt % to 30 wt % of microfibrillated cellulose fibrils based on total weight of the composition, and/or comprising 50 wt % to 70 wt % cellulose fibers, wherein at least 40 wt % and preferably at least 50 wt % of the cellulose fibers have an average fiber length of at least 4 mm;
b) subjecting the composition to a force having a pressure in particular of at least 7 MPa such that a core layer is obtained; and
c) attaching at least one decorative top layer to the upper core surface of the layer, preferably by applying heat and/or pressure.

40-43. (canceled)
